(19) United States
(12) Patent Application Publication
(10) Pub. No.: US 2002/0189454 A1
(43) Pub. Date: Dec. 19, 2002

(54) Method for capturing fine particles by percolation in a bed of granules

(76) Inventor: Michel Perrut, Nancy (FR)

Correspondence Address: ALLEN BLOOM, C/O DECHERT, PRINCETON PIKE CORPORATION CENTER, P.O. BOX 5218, PRINCETON, NJ, 08543-5218, US

(21) Appl. No.: 10/149,795

(22) PCT Filed: Dec. 15, 2000
(86) PCT No.: PCT/FR00/03558

(30) Foreign Application Priority Data
Dec. 15, 1999 (FR) 99/15834

(51) Int. Cl. B01D 46/30

(52) U.S. Cl. 95/274; 55/512

(57) ABSTRACT

The invention concerns a method for capturing very fine particles generated by a process using a supercritical pressurized fluid and a device therefor. Said method is characterized in that it consists in percolating, in a capture chamber, said fluid loaded with particles through a receptor bed consisting of granules.

The present invention relates to a method for ensuring capture of solid particles of great fineness, as well as to a device for carrying out this method.

Numerous industries use solids in pulverulent form. This is particularly the case of industries manufacturing paints, cosmetic and dermatological products, and pharmaceutical products. For example, the pharmaceutical industry, but also the cosmetics industry, requires novel galenic forms in order to improve the service rendered by the molecules of therapeutic or dermatological interest. In particular, it is seeking the means for effecting a rapid dissolution of these molecules, which are in the form of solid powder under usual conditions, within biological fluids such as blood or lymph. To that end, it is necessary either to modify the morphology of the solid, or to reduce the granulometry of the powder very considerably, or to combine these two actions. Numerous works are also carried out with a view to elaborating complex medicaments allowing a slow and regular absorption of the active molecule (delayed-action drug).

It is known, by numerous Patents and scientific publications, that microparticles can be obtained, with a granulometry generally included between 1 μm and 10 μm, and nanoparticles with a granulometry generally included between 0.1 μm and 1 μm, by using methods employing supercritical fluids.

Supercritical fluids, and particularly supercritical carbon dioxide, are widely used to produce very fine powders capable of dissolving very rapidly by ingestion through the respiratory tracts. Supercritical fluids are also used for obtaining complex particles constituted by mixtures of different morphologies of the active principle and of an excipient, such as microspheres or microcapsules.

It will firstly be recalled what such a supercritical fluid is.

In effect, it is known that bodies are generally known in three states, namely solid, liquid or gaseous and one passes from one to the other by varying the temperature and/or the pressure. Now, there exists a point beyond which one can pass from the liquid state to the gas or vapour state without passing through a boiling or, inversely, through a condensation, but continuously: this point is called the critical point.

It is also known that a fluid in supercritical state, i.e. a fluid which is in a state characterized either by a pressure and a temperature respectively higher than the critical pressure and temperature in the case of a pure body, or by a representative point (pressure, temperature) located beyond the envelope of the critical points represented on a diagram (pressure, temperature) in the case of a mixture, presents, for very numerous substances, a high solvent power with no comparison with that observed in this same fluid in the state of compressed gas.

The same applies to so-called “subcritical” liquids, i.e. liquids which are in a state characterized either by a pressure higher than the critical pressure and by a temperature lower than the critical temperature in the case of a pure body, or by a pressure greater than the critical pressures and a temperature lower than the critical temperatures of the components in the case of a mixture (cf. the article by Michel PERRUT—Les Techniques de l'Ingénieur (Engineering Techniques) “Extraction by supercritical fluid, J2 770-1 to 12, 1999”).

The considerable and modulatable variations of the solvent power of the supercritical fluids are, furthermore, used in numerous methods of extraction (solid/fluid), of fractionation (liquid/fluid), of analytical or preparative chromatography, of treatment of materials (ceramics, polymers) and of particle generation. Chemical or biochemical reactions are also made in such solvents. It should be noted that the physico-chemical properties of carbon dioxide as well as its critical parameters (critical pressure: 7.4 MPa and critical temperature: 31° C.) make it the preferred solvent in numerous applications, all the more so as it does not present any toxicity and is available in very large quantities at very low price. Non-polar solvent, carbon dioxide taken to supercritical pressure sometimes has a co-solvent added thereto, constituted in particular by a polar organic solvent whose function is considerably to modify the solvent power, especially with respect to molecules presenting a certain polarity, ethanol often being used to that end. However, certain compounds are more favourably extracted by a light hydrocarbon having from 2 to 5 carbon atoms, and more favourably, from 2 to 4 carbon atoms, at supercritical pressure.

Among the methods allowing very fine particles to be obtained by means of a fluid at supercritical pressure, the method known under the designation of “RESS” will be particularly retained, according to which a solution of the product to be atomized is expanded very rapidly in a supercritical fluid, and the anti-solvent method of the type of the so-called “SAS”, “SEDS”, “PCA”, “ASES” methods, consisting in pulverizing a solution of the product in an organic or aqueous solvent within a stream of fluid in supercritical state.

These methods allow a powder to be obtained, formed by very fine particles which are dispersed within a gaseous stream at low pressure (RESS method) or at high pressure (SAS method).

The collection of these particles is then a very delicate operation, especially when it is desired that productions be large-scale. In effect, on a laboratory scale, the generated particles are captured by filtration on a woven or non-woven filtering member generally disposed at the bottom of the recipient where the generation of the particles is effected. The recovery of the particle-laden filter and the collection of the particles therefore necessitate the complete depressurization of this recipient, its opening and the manipulation of the filter. This procedure is not compatible with the hygiene and safety requirements in force in the pharmaceutical industry, as a part of the fine particles is found in the atmosphere with the risks of inhalation by the staff present, and contamination of the drug thus atomized is also to be feared. Finally, it is obvious that such a procedure is expensive and hardly adapted to an extrapolation on a large scale.

Various methods allowing fine particles to be collected within a gaseous stream at a pressure close to atmospheric pressure, are, of course, known, particularly in the field of dedusting. The different dedusting methods and equipment used at the present time are adapted to the size of the particles to be captured. The following will be retained:

Inertial devices, such as baffles and cyclones, which are efficient for capturing particles whose diameter is greater than 10 or 20 μm;

Electrostatic devices such as the dedusters used for the treatment of fumes from coal-fired boilers, which are complex apparatus, efficient for capturing very fine particles with a diameter greater than about 1 μm.

Gas washers of different designs which are adapted to capture particles depending on their diameter, the most efficient being Venturi tube washers which makes it possible to capture particles of submicronic diameters.

Filters constituted by woven or non-woven filtering materials which make it possible to capture the finest particles including those whose diameter is included between 0.1 and 1 μm.

However, each of these techniques presents limitations depending on the characteristics of the particles to be captured.

In the case of fine particles for pharmaceutical or cosmetic use, it is clear that the inertial devices are not efficient enough and that the electrostatic devices cannot be used for reasons of cost and of safety. There therefore remain only the washers and the filters.

The washers can be employed only if it is accepted to collect the particles in the form of a dispersion within a liquid where they are strictly insoluble; it is rare that subsequent use allows the employment of such a dispersion.

The filters also present a notorious drawback, insofar as the recovery of the particles that they have fixed as well as their possible subsequent re-use, are operations which are particularly difficult to carry out as long as it is desired to respect the rules imposed in the pharmaceutical industry.

The present invention has for its object to propose a method, as well as means for carrying out this method, which make it possible easily to capture such particles and which, in addition, lends itself to continuous operation on an industrial scale.

The present invention thus has for its object a method for capturing very fine particles generated by a method using a fluid at supercritical pressure, characterized in that there is percolated, in a treatment chamber, said fluid laden with particles through a receptor bed constituted by granules. The fluid at supercritical pressure will preferably be constituted by carbon dioxide.

These very fine particles will thus be trapped principally in the extra-granular porosity but may also diffuse within the very granules when they present a high porosity constituted by pores of diameters greater than those of the particles generated.

In a particularly interesting form of embodiment of the invention, the particles will be constituted by an active principle and the granules will be constituted by an excipient intended to fix the latter. The particle-laden granular bed (active principle) may be recovered and used, directly, to make tablets, fill capsules or any other presentation intended for therapeutical use, in human or veterinary pharmacy, cosmetic or phytosanitary.

The present invention makes it possible to effect a continuous capturing of the particles and, to that end, the treatment chamber will be supplied with granules contained in a storage recipient forming lock chamber with respect to said chamber. Similarly, the treated granules contained in the treatment chamber will be collected in a reservoir forming lock chamber with respect to the chamber.

Furthermore, the flowrate of supply of the treatment chamber by the granules contained in the storage recipient will be close to the flowrate of drawing-off effected in said chamber.

The present invention also has for its object a capturing device comprising a capture chamber for fine particles generated thanks to a method employing a fluid at supercritical pressure, characterized in that it comprises, in its upper part, means for supplying particles to be captured and, in its lower part, a bed of granules intended to fix the particles, and means for supplying and evacuating a fluid at supercritical pressure intended to convey said particles.

The lower part of the capture chamber will preferably form a downwardly convergent hopper which will be in communication with reception/storage means able to form a lock chamber with respect to the treatment chamber.

Forms of embodiment of the present invention will be described hereinafter by way of non-limiting example, with reference to the accompanying drawing, in which:

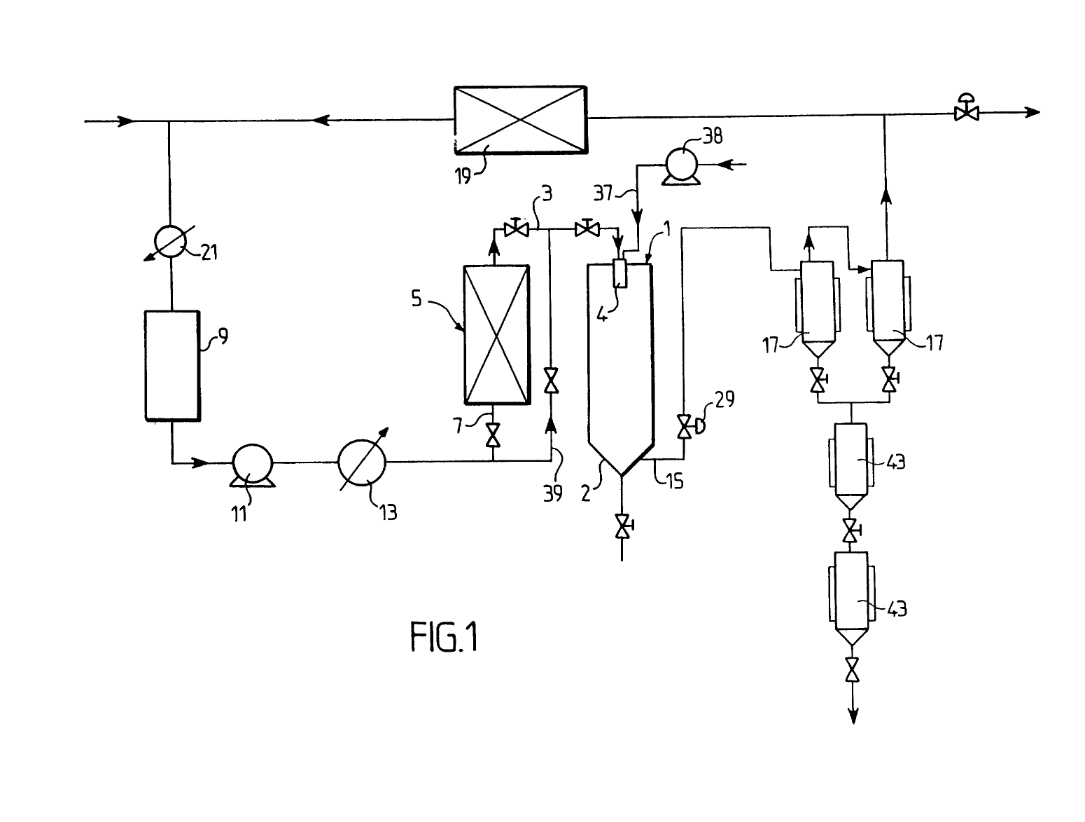

FIG. 1 schematically shows a particle producing and capturing installation according to the invention.

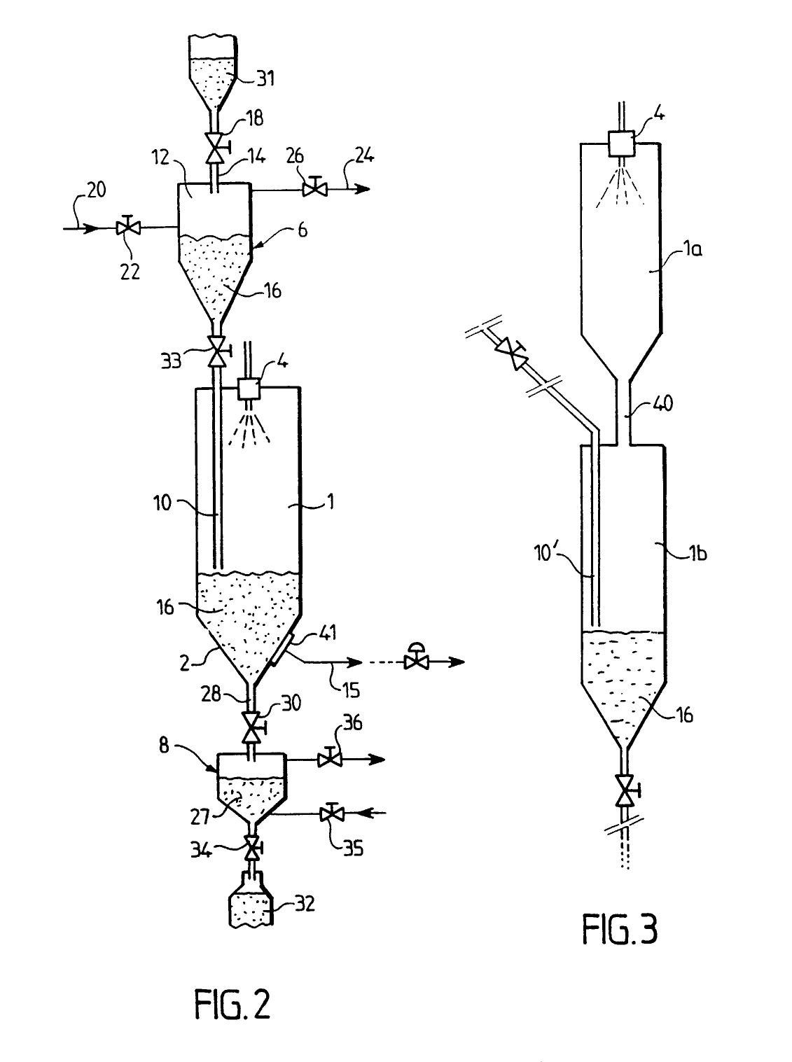

FIG. 2 is a diagram showing the detail of the means for capturing the particles employed in the installation shown in FIG. 1.

FIG. 3 is a variant embodiment of the invention shown in FIG. 2.

FIG. 1 shows a device for producing and capturing extra fine particles according to the invention. This installation is essentially constituted by an atomization chamber 1, represented in detail in FIG. 2, which is connected by a pipe 3 to the upper part, or outlet, of an extractor 5 or, by a pipe 37, to a liquid injection pump 38.

When the particle generation method is of RESS type, the extractor 5 is supplied at its base by a pipe 7 connected to a reservoir 9 for storing liquefied gas via a diaphragm pump 11 and an exchanger 13 which make it possible to take the liquefied gas to the desired pressure and temperature.

When the particle generation method is of anti-solvent type, the extractor 5 is not used and the fluid issuing from the exchanger 13 is directly supplied to the atomization chamber 1 via the pipe 39, the solution of the product to be atomized in an organic or aqueous solvent being introduced in the upper part of the atomization chamber 1 via the pipe 37 and the pump 38.

More precisely, the atomization chamber 1 is constituted, as shown in FIG. 2, by a tubular recipient of vertical axis which terminates at its base in a conical bottom 2 with a cone angle of the order of 45°. This atomization chamber 1 comprises, in its upper part, an injection nozzle 4 supplied by the pipe 3 connected to the extractor 5, and, in its lower part, an outlet of the fluid at supercritical pressure formed by a filter pellet 41 made of sintered metal in communication with the pipe 15.

The atomization chamber 1 contains granules 16 intended to fix the particles of very small dimension. The supply of granules 16 of the atomization chamber 1, as well as the recovery of the granules treated therein are effected via two respective lock chamber systems, namely a supply lock chamber 6 and a recovery lock chamber 8.

The supply lock chamber 6 is constituted by a tube 10 which penetrates in the chamber 1 by the upper part thereof and which is connected to the lower part of a tight chamber 12 with the interposition of a valve 33. The chamber 12 is supplied in its upper part by a pipe 14 connected to a granule supply hopper 31 via a solid valve 18. The chamber 12 is furthermore connected, on the one hand, to a supply of pressurized fluid by a pipe 20 with the interposition of a valve 22 and, on the other band, to the outside by a pipe 24 with the interposition of a valve 26.

In such a form of embodiment of the invention, the granular bed will be constituted by granules 16 of a shape and size such that the bed laden with particles, in particular laden with active principle, can be easily recovered by a system of valves usually used for recovering solids.

Similarly, the recovery lock chamber 8 is constituted by a tight lower chamber 27 which is connected, by its upper part, to the base of the conical part 2 of the atomization chamber 1 by a tube 28 with the interposition of a solid valve 30. As for the lower part of the chamber 27, it is joined to a recovery recipient 32 with the interposition of a solid valve 34. This chamber 27 may also be placed in communication via a valve 35 with the circuit of fluid at supercritical pressure downstream of the exchanger 13 and via a valve 29 with the separators 17, so as to allow a stripping of the powder collected by a stream of fluid at supercritical pressure.

The overall functioning of the installation will firstly be described, then the specific functioning of the atomization chamber 1 and of its means for supplying and recovering the granules 16.

According to a known technique, for example here the so-called RESS technique, the product which it is desired to atomize is arranged in the extractor 5 and there is percolated therein a fluid at supercritical pressure, constituted in particular by carbon dioxide, which is stored in the reservoir 9. The fluid is taken to the working pressure by the diaphragm pump 11 and to the working temperature by the heat exchanger 13. The fluid at supercritical pressure having dissolved a certain concentration of the product, it is admitted into the atomization chamber 1 through the spray nozzle 4, through which it is suddenly expanded, generating the formation of particles which are fixed on the granules arranged in the chamber 1. The fluid is then evacuated to the atmosphere or possibly recompressed and recycled.

If, instead of the RESS technique, the particles are generated by another known technique, for example the anti-solvent atomization method, the atomization chamber 1 is directly supplied with the fluid at supercritical pressure coming from the reservoir 9 via the pump 11 and the exchanger 13 and there is pulverized a solution of the product which it is desired to atomize, which will previously have been dissolved in an organic or aqueous solvent, in the atomization chamber 1 via the nozzle 4, the pipe 37 and the pump 38. The particles thus generated are fixed on the granules arranged in the chamber 1. The fluid at supercritical pressure is then partially expanded to the recycling pressure and reheated in order to ensure vaporization of the fluid and separation of the major part of the solvent used to elaborate the initial solution of the product to be atomized. This solvent is recovered in the cyclone separators 17, then drawn off at atmospheric pressure through lock chamber 43. The fluid from which the major part of solvent has been removed is recycled, after possible purification on the absorbent bed 19, generally constituted by active charcoal, then liquefied in the condenser 21, and recovered in the fluid reservoir 9.

The means for supplying and recovering the granules, with which the atomization chamber 1 is equipped, are particularly advantageous insofar as they allow a continuous functioning of the whole of the installation, while, in the devices of the prior state of the art, where the particles were recovered on a filter arranged inside the atomization chamber, it was necessary, prior to this recovery, to effect a complete decompression of the atomization chamber and the opening thereof.

To admit the granules 16 inside the atomization chamber 1, they are firstly collected in the upper chamber 12 by opening the valve 18, the other valves in relation with this chamber 12 in that case being closed. The valve 18 is then closed and the fluid under pressure is admitted through pipe 20, by opening the valve 22, the other valves in relation with this chamber being closed. When the pressure in this chamber attains a value slightly greater than that prevailing in the atomization chamber, the valve 22 is closed and the valve 33 is opened, so that the granules are propelled under pressure into the chamber 1. The valve 33 is then closed and valve 24 is opened in order to depressurize the chamber 12 with a view to a fresh cycle of filling.

Once the operation of capturing the fine particles is terminated, when it is desired to recover the granules treated in the chamber 1, the valve 30 is opened and the treated granules are recovered in the lower chamber 27. After closure of the valve 30 and opening of the valve 34, the treated granules are recovered in the recipient 32.

When the particle generating method is of the anti-solvent type, it is preferable to effect stripping of the organic solvent having served to prepare the initial solution of the product to be atomized, present on the granules and particles thus collected, this operation advantageously being able to be carried out by sweeping the granules with a stream of fluid at supercritical pressure entering through valve 35 and exiting through valve 36.

According to the invention, the flowrate of drawing-off of the granules will be regulated by weighing the mixture collected, so that it is equal to the input flowrate and that the volume of the granular bed in the chamber 1 is thus maintained at a constant value.

It is thus possible to generate the particles continuously, to capture them and recover them without it being necessary, between the treatment of two successive batches, to be obliged to place the treatment chamber at atmospheric pressure. Furthermore, it has been observed that the fact of working continuously made it possible to obtain very homogeneous batches of product, unlike those obtained according to the prior state of the art, i.e. conventional functioning in batches.

### EXAMPLE 1

The installation described hereinabove, provided with an atomization chamber with a total volume of 8 liters, was used to extract caffeine by a fluid at supercritical presure and to generate fine particles by expansion of this fluid according to the RESS technique, this fluid being constituted by carbon dioxide at supercritical pressure at a pressure 30 Mpa and at a temperature of 60° C. and a flowrate of 14 kg/hr. The particles were captured on a bed of granules of excipient, constituted by powder of hydroxypropylcellulose and of silica, 90% of the granules having a diameter included between 100 μm and 300 μm and being in the form of an easily flowing powder. This bed, constituted by 800 g of granules, was placed in position when the installation was started up, and it was supplied with 90 g of granules every twelve minutes while drawing off 100 g of solids likewise every twelve minutes, so that the mass of granules present in the chamber is approximately constant. The first five batches of powder were eliminated then, on each of the following batches recovered, an analysis was made of the caffeine content by HPLC liquid phase chromatography after dissolution of the caffeine in water.

An excellent reproducibility was observed of the caffeine content of each batch obtained during an operation having lasted 8½ hrs, this content remaining included between 10.5 and 11.8 g of caffeine for 100 g of mixture.

### EXAMPLE 2

In a second example of embodiment of the invention and using the same installation, very fine particles of tetracycline were generated in accordance with the SAS anti-solvent method, in which one pulverized a solution of 5% by mass of tetracycline in N-methylpyrrolidone with a flowrate of 0.6 kg/hr in a stream of 15 kg/hr of carbon dioxide at supercritical pressure, namely 18 MPa and 45° C.

The particles were captured in a bed of granules of excipient constituted by a mixture of powders of hydroxypropylcellulose (50% by weight) and of silica (50% by weight). 90% of the granules presented a diameter included between 100 μm and 300 μm, so that they were in the form of an easily flowing powder. This bed, constituted by 800 g of granules, was placed in position when the installation was started up, and it was supplied with 100 g of granules every fifteen minutes through the lock chamber 6 while drawing off 100 g of solid every fifteen minutes likewise through the lock chamber 8, so that the mass of granules present in the chamber is approximately constant.

According to the invention, at each cycle of sampling, the powder was drawn off, through the lock chamber 8 and stripped for 10 minutes by a stream of carbon dioxide at 18 Mpa, at a temperautre of 45° C. and with a flowrate of 3 kg/hr. The lock chamber was then decompressed down to atmospheric pressure before the final drawing-off of the powder obtained.

The first six batches of powder thus recovered are discarded. Each following batch was recovered separately and the content of tetracycline was determined by liquid phase chromatography after dissolution of the tetracycline in water.

An excellent reproducibility of the content of each batch during an operation having lasted 8 hours was observed, this content remaining included between 7.2 and 7.9% in the final powder. The N-methylpyrrolidone content of this powder, determined by gaseous phase chromatography of the aqueous phase obtained by prolonged stirring of the powder under ultrasounds, remained lower than 100 ppm for all the batches.

In a form of embodiment of the invention shown in FIG. 3, the atomization chamber 1 was divided up into two distinct chambers, namely an atomization chamber proper where the fine particles are produced and a capture chamber where the fine particles produced are captured by the granules.

More precisely, the installation thus comprises an atomization chamber 1a which is of the same shape as that shown in FIG. 2, and which is in communication by its bottom and a pipe 40 with the upper part of a capture chamber 1b of the same shape, which contains the bed of granules 16. The supply of granules of the capture chamber 1b is ensured by a conduit 10′ connected to a supply lock chamber of the type such as that shown in FIG. 2.

Such a form of embodiment is particularly advantageous in the domain of industrial exploitation insofar as it makes it possible to employ a plurality of atomization chambers and a plurality of capture chambers, used and cleaned successively.

The experiments carried out under initial conditions identical to those described in the preceding Examples have shown that the results obtained were quite comparable apart from the fact that the getting up speed proved longer due to the initial deposit of fine particles on the lower cone of the atomization chamber.

1. Method for capturing very fine particles generated by a method using a fluid at supercritical pressure, characterized in that there is percolated, in a capture chamber (1, 1b), said fluid laden with particles through a receptor bed consisting of granules.

2. Method according to claim 1, characterized in that the particles are constituted by an active principle and the granules are constituted by an excipient intended to fix the latter.

3. Method according to one of claims 1 or 2, characterized in that a fluid at supercritical pressure constituted by carbon dioxide, is used.

4. Method according to one of the preceding claims, characterized in that the capture chamber (1, 1b) is supplied with granules (16) contained in a storage recipient (12) forming lock chamber with respect to said chamber (1, 1b).

5. Method according to claim 4, characterized in that the treated granules (16) contained in the capture chamber (1, 1b) are removed in order to collect them in a recipient (27) forming lock chamber with respect to the chamber (1, 1b).

6. Method according to one of claims 4 or 5, characterized in that the flowrate of supply of the capture chamber (1, 1b) by the granules (16) contained in the storage recipient (12) is close to the flowrate of sampling effected in said chamber (1, 1b).

7. Device for capturing fine particles generated thanks to a method employing a fluid at supercritical pressure, characterized in that it comprises a capture chamber (1, 1b) provided in its upper part with means for supplying particles to be captured and, in its lower part, a bed of granules intended to fix the particles, and means for supplying and evacuating a fluid at supercritical pressure intended to convey said particles.

8. Capturing device according to claim 7, characterized in that the lower part of the capture chamber (1, 1b) forms a downwardly convergent hopper which is in communication with reception/storage means (8).

9. Capturing device according to claim 8, characterized in that the reception/storage means (8) form a lock chamber with respect to the capture chamber (1).

10. Capturing device according to one of claims 8 or 9, characterized in that the means (6) for supplying particles to be captured form a lock chamber with respect to the capture chamber (1).
